(19) United States
(12) Patent Application Publication
(10) Pub. No.: US 2008/0141995 A1
(43) Pub. Date: Jun. 19, 2008

(54) Apparatus and Method for Roughing Surfaces of Concrete Casted Blocks

(75) Inventors: Wallace Grubb, Saint-Basile-le Grande (CA); Benoit Slavinski, Saint-Basile-le-Grand (CA)

Correspondence Address: VENABLE LLP, P.O. BOX 34385, WASHINGTON, DC, 20043-9998, US

(73) Assignee: Grubb-AMC Inc., Longueuil (CA)

(21) Appl. No.: 11/883,636

(22) PCT Filed: Feb. 3, 2005
(86) PCT No.: PCT/CA2005/000139

§ 371 Date: Aug. 3, 2007

(51) Int. Cl. B28D 1/26

(52) U.S. Cl. 125/40

(57) ABSTRACT

An apparatus and method for roughing the surface and edges of concrete casted blocks, such as concrete pavers is described herein. The apparatus comprises an elongated block-receiving surface having first and second longitudinal end portions and provided with block-tilting elements for sequentially tilting up at least two upper edges of a block moving on the surface from a first end portion to a second end portion; means for moving blocks on the block-receiving surface from the first to second end portions; and a plurality of impacting elements located above the block-receiving surface for reciprocating movement towards and away the block-receiving surface for impacting blocks on the block-receiving surface. The tilting elements may be in the form of wheels rotatably mounted to the block-receiving surface and positioned for sequentially tilting up each of the four upper edges of the block moving on the surface.

The present invention relates to concrete casted blocks such as concrete paver. More specifically, the present invention is concerned with an apparatus and method for roughing surfaces of concrete casted blocks.

### BACKGROUND OF THE INVENTION

Many apparatuses and methods are known for roughing the surfaces and edges of concrete blocks such as paving blocks in order to provide a natural or so-called antique look.

Such apparatus and method are described by Hagenah in U.S. Pat. No. 6,749,793 entitled “Method and Device for Mechanically Treating Concrete Blocks”, issued on Jun. 15, 2004. Hagenah teaches placing concrete blocks on an inclined table top and moving treatment bodies, harder than concrete, over the top surface of the concrete blocks. A drawback of Hagenah's method it is complicated to implement and requires frequent changes of treatment bodies.

In U.S. Pat. No. 6,668,816, issued to Pedersen et al. on Dec. 30, 2003 and entitled “Concrete Stone Texturing Machine, Method and Product”, a machine is taught that conveys stones having opposed flat surfaces to a pitching station having pair of opposed pitching blade assemblies aligned in a common plane on a respective side of the pitching station. A unique appearance is obtained when the pitching blades are forced to penetrate a predetermined distance in the associated faces of the block. A first drawback of this last method and machine is that the conveyed stones have to be precisely aligned with the pitching station and therefore means are to be provided to insure such alignment. Moreover, a post treatment has to be provided to smooth the resulting surface that exit the pitching station with unrealistically sharp edges. Another drawback is that the machine is very complex and therefore relatively costly, for example to operate and maintain. Finally, the resulting blocks being similarly worn and looking alike, thus partly defeating the purpose of trying to provide a unique antique look to the blocks.

Another example of apparatus for roughing concrete casted blocks is described in U.S. Pat. No. 6,575,727, entitled “Apparatus for Roughing Surfaces of Concrete Casted Blocks”, and issued to Ciccarello et al. on Jun. 10, 2003. Ciccarello's apparatus includes a plurality of endless conveyors, each made of a plurality of tilting panel for both conveying concrete blocks and for projecting a leading edge of the block over the surface when the block is positioned below a roughing device in the form of rotating elements provided with chains at its periphery, the tips of which aiming at impacting the projecting edge of the block. One of the problems of such an apparatus is that an important number thereof is required to realistically rough the four top edges of the blocks. Moreover, the use of chains wears the concrete blocks very locally and often in a very regular manner due to the constant movement of the rotary chains and to the precise location of a chain along a rotating element, which, similarly to the use of knives mentioned above, will result in block being similarly worn and looking alike.

Some of the above described drawbacks are solved by Ciccarello in U.S. Pat. No. 6,561,786 issued on May 13, 2003 and entitled “Apparatus for Roughing Surfaces of Concrete Casted Blocks”. This second apparatus from Ciccarello includes a support table having an upper surface and block tilt support pins that selectively project therefrom for supporting some of the blocks tilted at a predetermined angle. The support pins are displaceable from a retracted position below the upper surface to a projecting position. The apparatus further includes roughing devices, in the form of rotating elements provided with chains at its periphery, the tips of which aiming at impacting the projecting edge of the block. The chains are mounted to the shaft so as to be axially movable thereon.

Even though the chains are made axially movable compared to the previous described apparatus from Ciccarello et al., the use of chain still cause the concrete blocks to wear too locally due to the constant movement of the rotary chains, which, will result in block being similarly worn and looking alike. Moreover, the apparatus only allows wearing two opposite edges on a single pass and therefore requires a minimum of two passes two wear the four edges. Finally, the block tilt support mechanism is complicated and cannot be adapted to accommodate blocks of different sizes from pass to pass.

### OBJECTS OF THE INVENTION

An object of the present invention is therefore to provide improved apparatus and method for roughing surfaces of concrete casted blocks.

### SUMMARY OF THE INVENTION

More specifically, in accordance with the present invention, there is provided an apparatus for roughing surfaces of concrete casted blocks comprising:

an elongated block-receiving surface having first and second longitudinal end portions and provided with block-tilting elements for sequentially tilting up at least two upper edges of blocks moving on the surface from the first end portion to the second end portion;

means for moving blocks on the block-receiving surface from the first to second end portions; and

at least one impacting device located above the block-receiving surface for reciprocating movement towards and away the block-receiving surface for impacting blocks on the block-receiving surface.

In accordance to a second aspect of the present invention there is provided a method for roughing surfaces of concrete casted blocks comprising:

generally aligning the blocks on an block-receiving surface having first and second longitudinal end portions;

moving the blocks on the block-receiving surface from the first to second end portions;

sequentially raising at least three adjacent upper edges of each block; and

impacting the raised edges of the blocks.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is a side elevation of an apparatus for roughing surfaces of concrete casted blocks according to a first illustrative embodiment of the present invention;

FIG. 2 is a top plan view of the apparatus from FIG. 1;

FIG. 3 is a perspective view of the block-receiving surface of the apparatus from FIG. 1, illustrating a first illustrative embodiment of the block-tilting elements according to the present invention;

FIGS. 4A-4C are cross-sections respectively taken along lines 4A-4A, 4B-4B and 4C-4C on FIG. 3;

FIG. 5 is a partial perspective view of the apparatus from FIG. 1, illustrating a first group of impacting devices mounted above the block-receiving surface;

FIG. 6 is a perspective view of one of the impacting devices from FIG. 5;

FIG. 7 is a side elevation of the impacting assembly part of the impacting device from FIG. 6;

FIG. 8 is a top plan view illustrating concrete casted blocks resulting through the use of the apparatus from FIG. 1 from regular shaped concrete casted blocks;

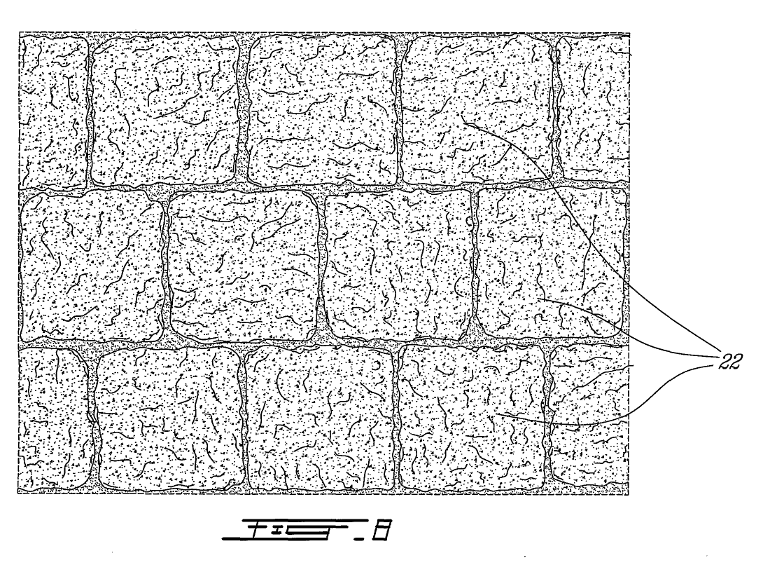

FIG. 9 is perspective view of a second illustrative embodiment of a block-receiving surface provided with tilting elements according to the present invention;

FIG. 10 is a side elevation similar to FIG. 7, of a third illustrative embodiment of tilting elements according to the present invention;

FIG. 11 is a partial side elevation view illustrating a second illustrative embodiment of an impacting device according to the present invention;

FIGS. 12A-12H are side elevations illustrating the effect of the position of the wheels part of the apparatus from FIG. 1 relatively to the center of a block on the biasing height of the block for different position for different width of the block, and for a first diameter of wheels;

FIGS. 13A-13H are side elevations illustrating the effect of the position of the wheels part of the apparatus from FIG. 1 relatively to the center of a block on the biasing height of the block for different position for different width of the block, and for a second diameter of wheels; and

FIGS. 14A-14H are side elevations illustrating the effect of the position of the wheels part of the apparatus from FIG. 1 relatively to the center of a block on the biasing height of the block for different position for different width of the block, and for a third diameter of wheels.

### DETAILED DESCRIPTION

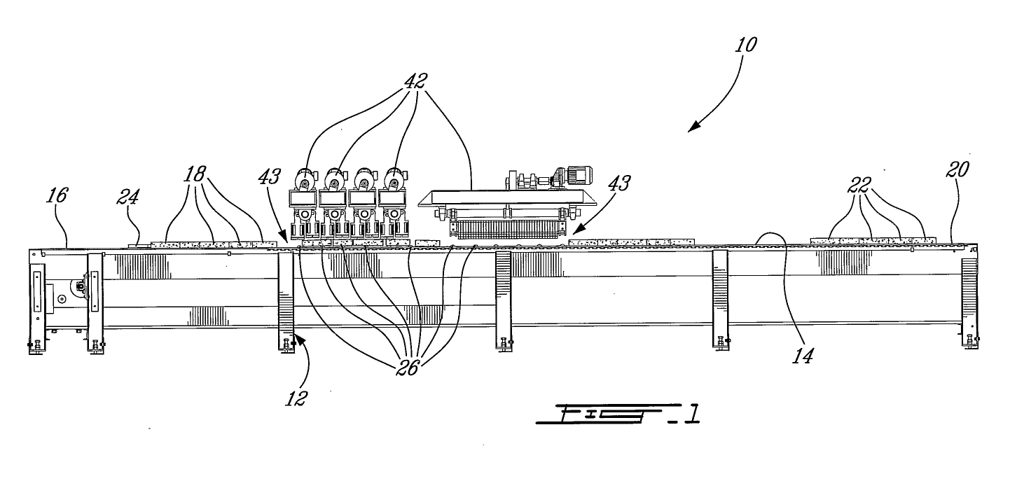

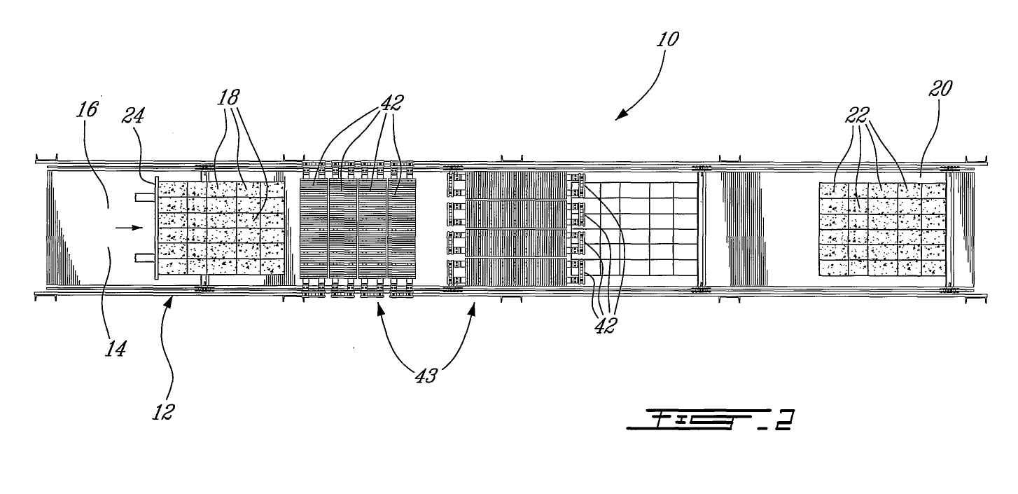

An apparatus 10 for roughing surfaces of concrete casted blocks according to a first illustrated embodiment of the present invention will now be described with reference to FIGS. 1-2. As will become more apparent upon reading the following non-restrictive description, the apparatus 10 allows roughing the four upper edges of concrete casted blocks to produce, for example, concrete paver.

The apparatus 10 comprises a table 12 defining an elongated block-receiving surface 14 having a first longitudinal end portion 16 for receiving blank concrete blocks 18 and a second longitudinal end portion 20 for outputting the roughed blocks 22 and providing with motorized push bars 24 (only one shown) for moving the blocks 18 received on the block-receiving surface 14 from the first end 16 to the second end 20. The push bars 24 are motorized by a first drive motor 25 and corresponding drive assemblies (not shown). Since push bars 24 are believed to be well known in the art, and for concision purposes, they will not be described herein in more detail.

The table 12 is sized according to the size and number of blocks 18 to simultaneously treat as will become more apparent hereinbelow.

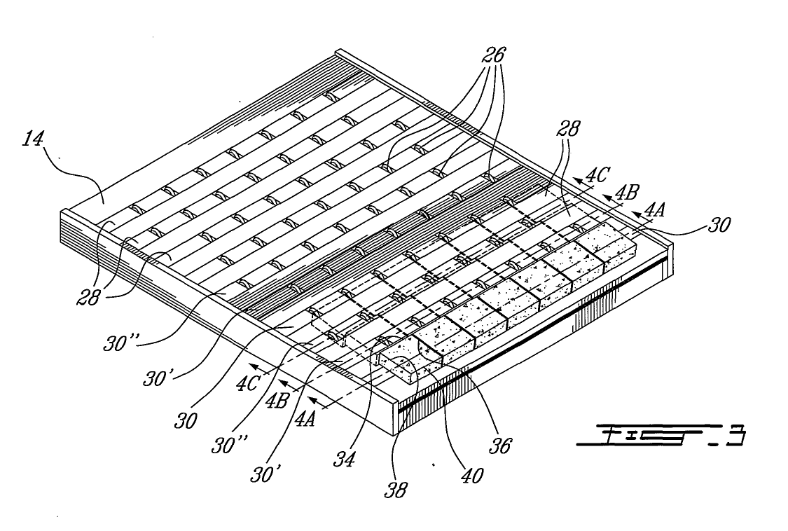

As can be seen on FIG. 1 and more specifically on FIG. 3, the block-receiving surface 14 of the table 12 is provided with block-tilting elements in the form of wheels 26 rotatably mounted to the surface 14 so as to extend partially therefrom. The wheels 26 are similar to the type used with line skates.

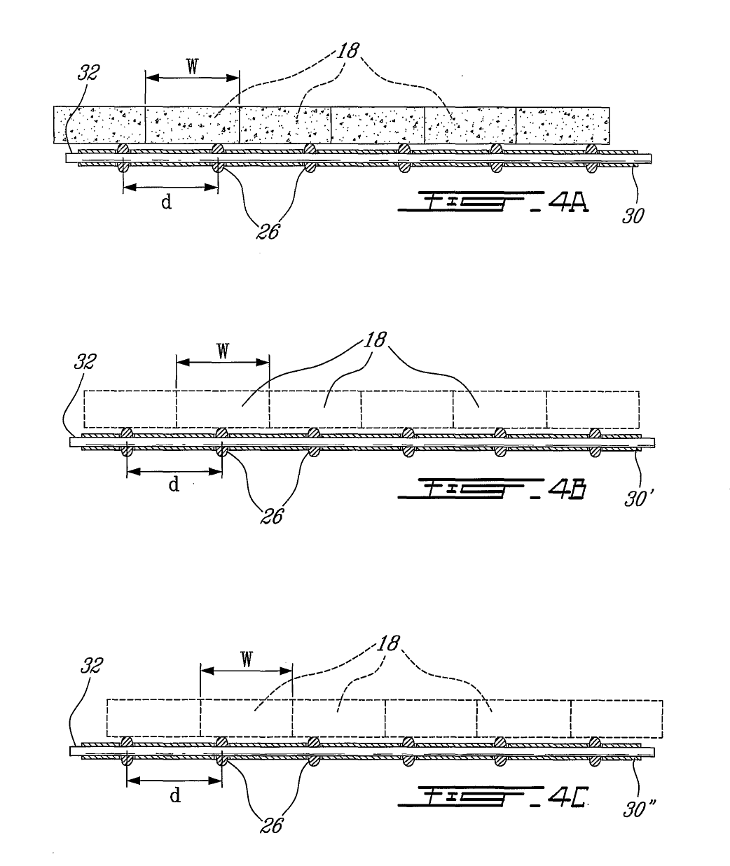

More specifically, the block-receiving surface 14 includes a series of alternating transversal flat tabs 28 and sequentially tabs 30, 30′, or 30″ provided with distanced wheels 26. The tabs 30, 30′ and 30″ are so mounted to the table 12 as to allow rotation of the wheels 26 (see FIGS. 4A, 4B and 4C).

Each row of wheels 26 on tabs 30, 30′ and 30″ is mounted to a transversal shaft 32 mounted to the table or tabs 30, 30′ and 30″ thereunder so as to be parallel. Of course, other means can alternatively be provided to rotatably mount the wheels 26 to the block-receiving surface 14 of the table 12. For example, H-shaped brackets (not shown) secured to the tab 30, 30′ and 30″ thereunder can be provided to secure the wheels 26. The wheels 26 are mounted to the block-receiving surface 14 for rotation about an axis parallel to each tab 30, 30′ and 30″ as can be seen in FIGS. 4A-4C.

As illustrated in FIGS. 4A-4C, the wheels 26 are so positioned on the block-receiving surface 14 for sequentially tilting up the four adjacent upper edges 34 to 40 of each block 18 moving on the surface 14.

More specifically, as illustrated in FIG. 4A, the wheels 26 are so mounted onto the first tab 30 encountered by the blocks 18 (and onto the third tab and so on) that their respective transversal position generally corresponds to the right of a block 18 so as to tilt (or project away from the surface 14) the right edge 36 thereof. The wheels 26 of the next encountered tab 30′ by each row of blocks 18 are transversally positioned so as to be positioned near the center edges 34 of the blocks (FIG. 4B) causing their tilting away from the surface 14. Of course, the same row 30 of wheels 26 will also cause the subsequent tilting of the back edge 40. Finally, the third encountered row 30″ causes the tilting of the left edge 38 of the blocks 40. Of course, the tilting sequence can be modified. It is to be noted that the blocks 18 are illustrated un-tilted on FIGS. 4A-4C only to simplify the view.

As illustrated in FIGS. 1-3, the apparatus 10 is provided with a plurality of such sequences of tabs 28-30-28-30′-28 and 30″ to increase the roughing action on the edges 34-40 on a single pass in combination with the impacting assemblies 44 as will be described furtherin in more detail.

The use of wheels 26 as tilting elements allows minimizing friction and therefore damages to the bottom surface of the blocks 18. Rolls or balls (not shown) could also be used instead of wheels 26.

As can be better seen on FIGS. 4A-4C, the tilting elements 26 are transversally separated from a distance ‘d’ generally corresponding to the average width ‘w’ of the blocks. The block-receiving surface 14 can of course be adapted for roughing blocks from different dimension. For that purpose, the block-tilting element assembly illustrated in FIG. 3 and more specifically the positions of the tilting elements 26 on the block-receiving surface 14 can be easily modified by using tabs configured so as to yield the appropriate overall configuration of the block-tilting elements 26.

The apparatus 10 further comprises a plurality of impacting devices (6 illustrated) 42 mounted above portions of the block-receiving surface 14 provided with tilting elements 26 for reciprocating movement towards and away the block-receiving surface 14 for impacting blocks 18 thereon as will be described hereinbelow in more detail. The combination of facing portion of the block-receiving surface 14 provided with tilting elements 26 and a series of consecutive impacting devices 42 will be referred to herein as an roughing station 43.

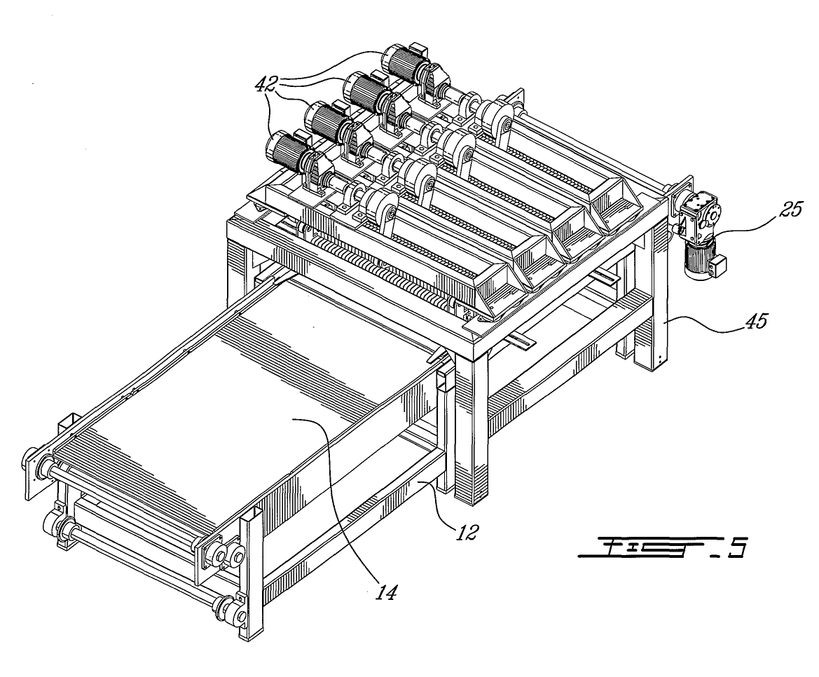

As shown in FIG. 5, the impacting devices 42 are mounted above the block-receiving surface via a table-shaped frame 45. Even though the impacting devices 42 according to the first illustrative embodiment is independent from the table 12, a common assembly may be provided to support the block-receiving surface 14 and mount the impacting devices 42 above the block-receiving surface 14.

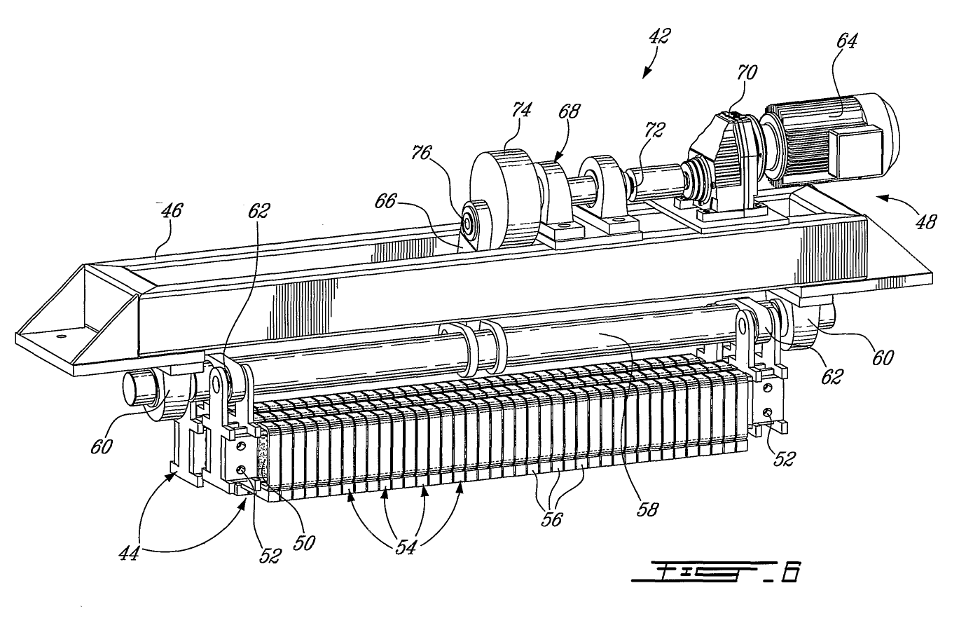

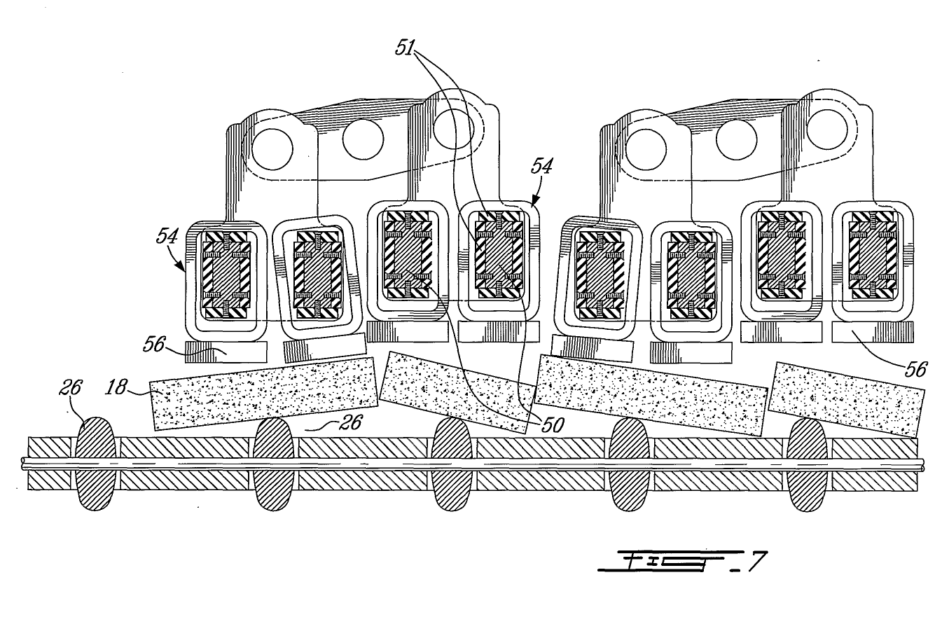

The impacting devices 42 will now be described in more detail with reference to FIGS. 6-7. Since all the impacting devices 42 are identical, and for concision purposes, only one impacting device 42 will be described herein in more detail.

The impacting device 42 comprises two pairs of impacting assemblies 44 mounted to a frame 46 for alternate reciprocation in an oscillating manner as will be described hereinbelow in more detail. The two impacting assemblies 44 are driven by a drive assembly 48.

Each impacting assembly 44 includes two pairs of generally rectangular beams 50, each pair being mounted between two end brackets 52 so that the two pairs are parallel. A plurality of impacting elements 54 are loosely received on each beam 50. Each impacting element 54 is in the form of a rectangular ring provided with an impacting head 56 integrally secured to its lower side. The impacting head 56 has a rectangular cross-section.

The inner periphery of each impacting element 54 is greater than the outer periphery of the beams 50 yielding a loose mounting of the rings 54 about the beam 50. Moreover, the impacting elements 54 are not so tightly mounted onto the beam 50 as to prevent translation therealong. Indeed, the number and configuration of the impacting elements 54 are so chosen as to allow a minimum longitudinal course of the impacting elements 54 along the beam 50. This last characteristic of the impacting device 42, in addition to the fact that the impacting head 56 has a a relatively wide surface and to the fact that each impacting element 54 is freely mounted about the beam 50 provides for a relatively smooth and a broad impact of the impacting elements 54 on the blocks 26. As can be better seen from FIG. 7, the rectangular beams 50 are covered with UHMW plastic plates 51 secured to the beam via bolts or other fastening means. The plates 51 aim at reducing both friction and noise during operation. The beams 50 can be covered with another resilient material such as rubber or another polymeric material.

The two pairs of impacting assemblies 44 are mounted to a rod 58 for swinging movement via two pivot members 62, each including a central opening for securing the member 62 to the rod 58 and two side apertures for mounting respective end bracket 52. The rod 58 is pivotably mounted to the frame 46 via two mounting bracket 60 provided with bearing means.

The swinging movement of the pair of impacting assemblies 44 is caused by pivoting the rod 58 back and forth partially in both directions, which is achieved by means of the drive assembly 48.

The drive assembly 48 comprises a drive motor 64 secured to the frame 46 via a gear box 70 and having a drive shaft (not shown) operatively coupled to a connecting rod 66 via a drive coupling assembly 68 for transferring the rotational movement of the output shaft of the drive motor 64 into a reciprocating movement of the connecting rod 66. More specifically, the drive coupling assembly 68 includes the gear box 70, secured to the frame 46, and having its input shaft coupled to the output shaft of the drive motor 64, a reinforced coupling shaft assembly 72 secured to the frame 46 and having its mechanical input coupled to the output of the gear box 70, and a coupling disk 74 having its input shaft (not shown) coaxially coupled to the output of the reinforced coupling shaft assembly 72, and its opposite output shaft 76 coupled to the connecting rod 66. The output shaft 76 is eccentrically positioned so as to transfer the rotational movement of the coupling disk 74 into a generally linear movement of the connecting rod 66. The reciprocating movement of the connecting rod causes the pivoting of the rod 58 back and forth in both directions.

In addition to the non rigid broad impact provided by the impacting device 42, which provides a random/“antique” look to the blocks 18, the impacting device 42 is configured for easy replacement of substitution parts, including the impacting elements 54 and impacting device 42.

Of course, other drive assembly can be used to impart an oscillating movement on the impacting assemblies 44. The configuration and size of the impacting elements 54 can also differ depending on the expected result and overall configuration of the apparatus 10 as will be described hereinbelow. For example, the impacting head can be rounded.

The overall operation of the apparatus 10 will now be described with reference to FIGS. 1 and 2.

A series of rows of concrete casted blocks 18 are fed on the block-receiving surface 14 of the table 12 at the first longitudinal end portion 16. The push bar 24 moves the blocks 18 on the block-receiving surface 14 towards the second end portion 20. When a row of blocks contacts a portion of the surface 14 provided with tilting elements 26, each of the four edges 34-40 of the blocks 18 are sequentially raised as described hereinabove and are impacted by the impacting assemblies 44 resulting in roughed and wore blocks 22 (see FIG. 7).

It is to be noted that the apparatus 10 comprises first and second roughing stations 43, the second roughing stations having its impacting devices 42 oriented perpendicularly to those of the first roughing station. This configuration of the apparatus 10 yields, for each roughing station 43, upper edges of blocks 18 being impacted both by impacting elements 56 oriented parallel thereof and perpendicular thereof.

An apparatus according to the present invention can be provided with one or a plurality of roughing stations. Their impacting devices 42 can be oriented parallel to the general orientation of the block-receiving surface, perpendicular thereof, angled and in any combination thereof when there is more than one roughing stations.

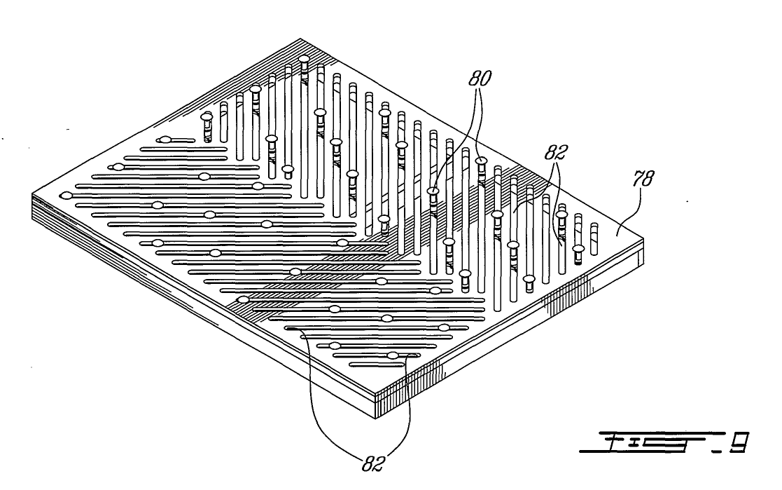

Turning now to FIG. 9, a second illustrative embodiment of a block-receiving surface 78 provided with tilting elements 80 according to the present invention will now be described.

The block-receiving surface 78 being provided with two series of symmetrically facing elongated oblique apertures 82, the tilting elements 80 are in the form movable elements protruding from a predetermined height from the surface 78. For example, bolts 80 provided with rounded head can be secured to the surface 78 using conventional nut (not shown) allowing modifying the overall configuration of the tilting elements 80 on the surface 78. Of course, the overall configuration of the apertures 82 may vary.

Alternatively, a block-receiving surface according to the present invention can be provided with tilting elements that are fixedly mounted to the block-receiving surface.

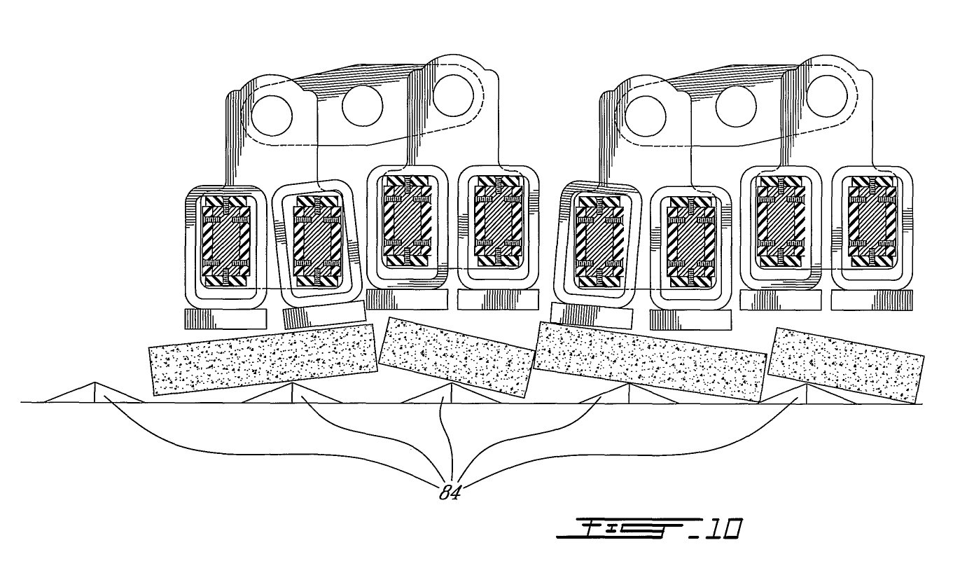

FIG. 10 illustrates a third illustrative embodiment of tilting elements 84 according to the present invention, where the tilting elements 84 are in the form of pyramid-shaped bodies.

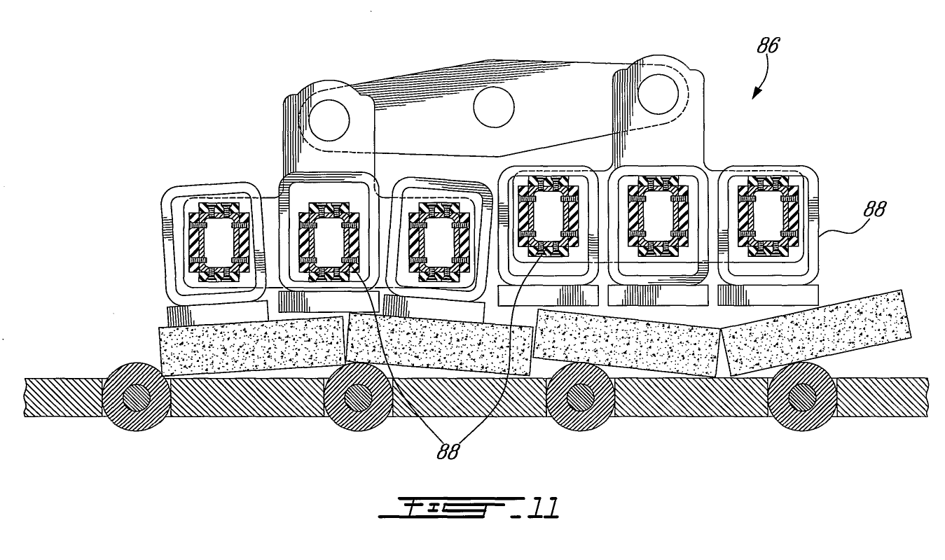

According to the present invention, each row of blocks 18 may cross the path of more than one roughing station 43, yielding a different look for the resulting roughed blocks 22. Examples of other parameters that can be modified to achieve a desired look include:
The size of the gap between the impacting elements 54 and the beam 50;
The shape and sizes of the impacting elements 54;
The course of the impacting devices 54;
The speed of the drive motor 64 and the configuration of the drive assembly 48;
The distance of the end course of the impacting elements 54 relatively to the maximum expected position of a block 18 when it is raised by a tilting element 26;
The conveying speed (translation speed of the push bar) 24;
The number of roughing stations 43, the number of impacting devices 42 by roughing stations 43, and the number of impacting assemblies 44 by impacting devices 42. For example, FIG. 11 illustrates part of an impacting device 86 including six (6) impacting assemblies 88.

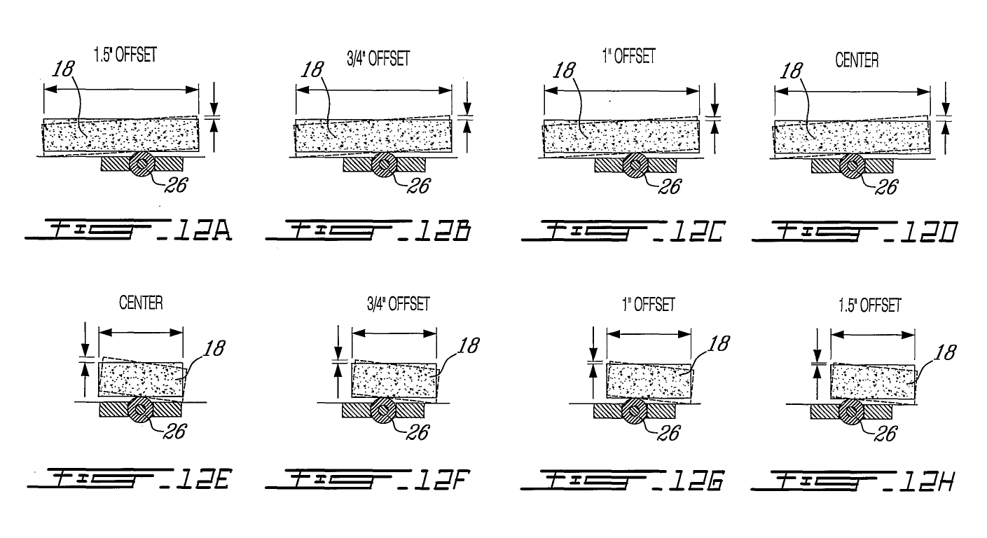

Referring to the apparatus 10 according to the first illustrative embodiment of the present invention, FIGS. 12A-12H show the effect of the position of the tilting element 26 relatively to the center of a block 18, for different position and for different width of the block, on the biasing height of the block 18 for wheels having a first diameter.

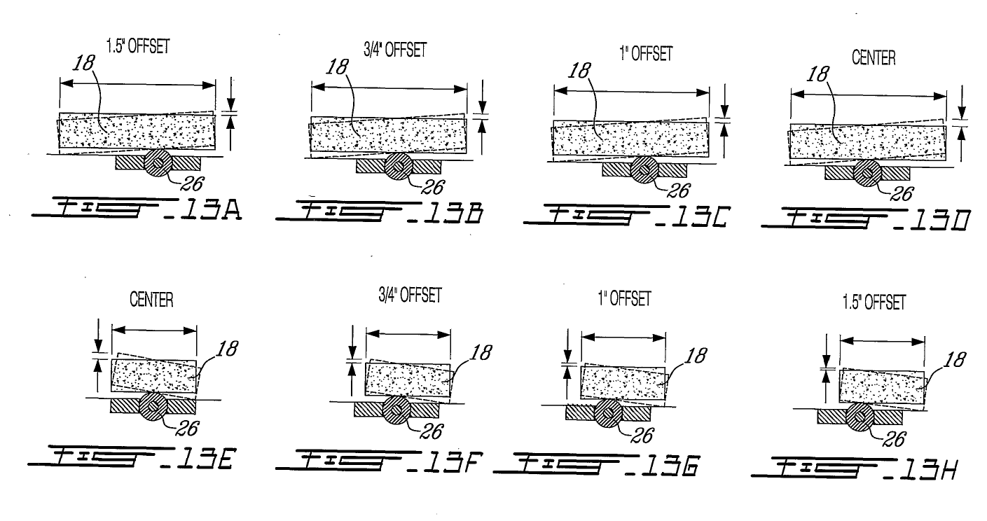

FIGS. 13A-13H show the effect of the position of the tilting element 26 relatively to the center of a block 18, for different position and for different width of the block, on the biasing height of the block 18 for wheels having a second diameter.

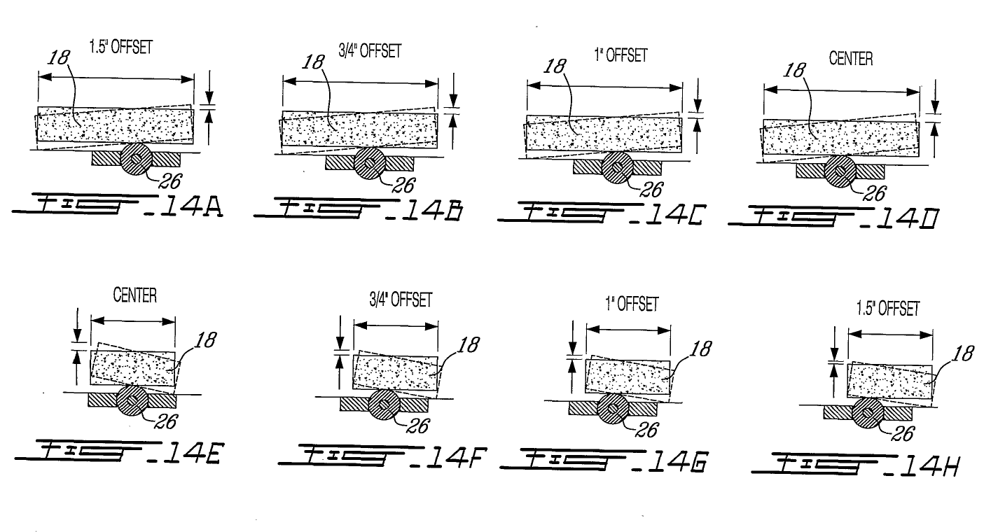

FIGS. 14A-14H show the effect of the position of the tilting element 26 relatively to the center of a block 18, for different position and for different width of the block, on the biasing height of the block 18 for wheels having a third diameter.

Of course, the choice of material for the impacting elements 54 also influences the wear on the blocks 18. The impacting elements 54 are made of steel or of any material harder that the concrete blocks 18.

The configuration of the impacting devices 42 can be modified without departing from the spirit and nature of the present invention. For example, an impacting device having a single impacting assembly can alternatively be used. The impacting devices can also be in the form of bush hammers.

Also, even though each impacting device 42 has been illustrated having its own drive motor 64, the roughing station 43 may be modified so that a single drive motor is used and shared by the entire impacting devices 42.

The number of push bars 24 may vary depending on the number of roughing stations 43 for example.

Even though the apparatuses according to the present invention have been described including push bars 24 to move the blocks 18 along the table, other means for moving blocks on the block-receiving surface can also be used. For example, the push bar can be replaced by an endless belt conveyor providing with a belt material sufficiently thin to allow the tilting element to cause local bump on the conveyor.

Finally, an additional surface wearing device may be added to an apparatus from the present invention to wear the upper surface of the concrete blocks 22. Such a device may include rotating chains as it is well known in the art.

Although the present invention has been described hereinabove by way of preferred embodiments thereof, it can be modified without departing from the spirit and nature of the subject invention, as defined in the appended claims.

What is claimed is:

1. An apparatus for roughing surfaces of concrete casted blocks comprising:
an elongated block-receiving surface having first and second longitudinal end portions and provided with block-tilting elements for sequentially tilting up at least two upper edges of blocks moving on said block-receiving surface from said first end portion to said second end portion;
means for moving blocks on said block-receiving surface from said first to second end portions; and
at least one impacting device located above said block-receiving surface for reciprocating movement towards and away said block-receiving surface for impacting blocks on said block-receiving surface.

2. An apparatus as recited in claim 1, wherein said block-tilting elements are in the form of wheels rotatably mounted to said block-receiving surface so as to extend at least partially upwardy therefrom.

3. An apparatus as recited in claim 1, wherein said block-tilting elements are in the form of rolls or balls rotatably mounted to said block-receiving surface so as to extend at least partially upwardly therefrom.

4. An apparatus as recited in claim 1, wherein said block-tilting elements are transversally separated from a distance generally corresponding to an average width of said blocks.

5. An apparatus as recited in claim 1, wherein said elongated block-receiving surface is provided with block-tilting elements for sequentially tilting up at least three adjacent upper edges of a block moving on said surface from said first end portion to said second end portion.

6. An apparatus as recited in claim 5, wherein said block-tilting elements are in the form of wheels rotatably mounted to said block-receiving surface so as to extend at least partially upwardly therefrom.

7. An apparatus as recited in claim 6, wherein each of said wheels is rotatably mounted to one of a plurality of tabs partly defining said block-receiving surface for receiving rows of blocks.

8. An apparatus as recited in claim 7, wherein said block-receiving surface includes at least one sequence of tabs provided with wheels for sequentially tilting each of the four upper edges of said blocks;
said at least one sequence of tabs including a first tab for tilting first edge of said blocks, a second tab for tilting opposite second and third edges of said blocks, and a third tab for tilting a fourth edge of said blocks; said first edge being generally oriented parallel to a moving direction of said blocks.

9. An apparatus as recited in claim 8, wherein said first tab is positioned first in said at least one sequence of tabs.

10. An apparatus as recited in claim 5, wherein said block-tilting elements are in the form of rounded elements mounted to said block-receiving surface.

11. An apparatus as recited in claim 10, wherein said block-receiving surface is provided with elongated apertures; said block-tilting elements are in the form of bolts removably secured in said apertures and provided with rounded head defining rounded elements on said block-receiving surface.

12. An apparatus as recited in claim 11, wherein said bolts are removably secured using a nut.

13. An apparatus as recited in claim 5, wherein said block-tilting elements are pyramid-shaped.

14. An apparatus as recited in claim 1, wherein said impacting device is elongated and is positioned generally parallel, generally perpendicular, or at an angle to said elongated block-receiving surface.

15. An apparatus as recited in claim 1, wherein said block-receiving surface includes at least one sequence of a first portion provided with block-tilting elements and a second portion free of block-tilting elements; one of said at least one impacting device being located above said first portion of said block-receiving surface.

16. An apparatus as recited in claim 15, comprising two of said at least one sequence wherein one of said at least one impacting device located above said first portion of said block-receiving surface of a first sequence and said at least one impacting device located above said first portion of said block-receiving surface of a second sequence is oriented generally parallel to said block-receiving surface and the other is oriented generally perpendicular.

17. An apparatus as recited in claim 1, wherein said block-tilting elements are transversally separated from a distance generally corresponding to an average width of said blocks.

18. An apparatus as recited in claim 1, wherein said at least one impacting device includes at least two impacting assemblies for alternate reciprocation.

19. An apparatus as recited in claim 17, wherein said at least two impacting assemblies are mounted to a rod for swinging movement.

20. An apparatus as recited in claim 19, wherein said rod is pivotably mounted to a support member and operatively coupled to a drive motor via a drive assembly including a connecting rod for coupling the output shaft of the drive motor to said rod.

21. An apparatus as recited in claim 1, wherein said at least one impacting device includes a beam reciprocally mounted to a frame and a plurality of rings loosely received on said beam thereabout sliding movement along said beam and for transversal movement relatively to said beam.

22. An apparatus as recited in claim 21, wherein said at least one of said plurality of rings are provided with and impact head.

23. An apparatus as recited in claim 22, wherein said impact head is at least one of rectangular shaped or rounded.

24. An apparatus as recited in claim 22, wherein said impact head is made of steel.

25. An apparatus as recited in claim 1, wherein said at least one impacting device is driven by a drive assembly including a drive motor.

26. An apparatus as recited in claim 1, wherein said means for moving blocks on said block-receiving surface from said first to second end portions includes a motorized push bar.

27. An apparatus as recited in claim 1, wherein said means for moving blocks on said block-receiving surface from said first to second end portions includes an endless belt conveyor provided with a belt material sufficiently thin to allow said tilting element to operate therethrough.

28. An apparatus as recited in claim 1, wherein said block-receiving surface is mounted to a table.

29. An apparatus as recited in claim 28, wherein said at least one impacting device is secured to said table.

30. An apparatus as recited in claim 29, further comprising means to further wear the upper surface of said blocks.

31. A method for roughing surfaces of concrete casted blocks comprising:
generally aligning the blocks on an block-receiving surface having first and second longitudinal end portions;
moving the blocks on the block-receiving surface from said first to second end portions;
sequentially raising at least three adjacent upper edges of each block; and
impacting the raised edges of the blocks.
